(19) United States
(12) Patent Application Publication
(10) Pub. No.: US 2025/0336158 A1
(43) Pub. Date: Oct. 30, 2025

(54) REMOTE PRESENCE ON AN XR DEVICE

(71) Applicant: Snap Inc., Santa Monica, CA (US)

(72) Inventors: Matthew Hallberg, Los Angeles, CA (US); Karen Stolzenberg, Venice, CA (US); Brian Wong, Murrieta, CA (US)

(21) Appl. No.: 18/648,801

(22) Filed: Apr. 29, 2024

(51) Int. Cl. G06T 19/00; G02B 27/01

(52) U.S. Cl. CPC G06T 19/006; G02B 27/017

(57) ABSTRACT

Example computer readable storage, extended reality (XR) wearable devices, and methods for remote presence are disclosed where example methods comprise: capturing, by an image capturing device of the XR wearable device, an image corresponding to a first user view of a real-world scene, sending the image to a computing device, receiving, from the computing device, an indication to pause sending next images to the computing device, and determining a plurality of three-dimensional (3D) coordinates corresponding to a plurality of positions within the image. The method may further include sending, to the computing device, the plurality of 3D coordinates corresponding to the plurality of positions within the image, and receiving, from the computing device, an indication of an augmentation and 3D coordinates associated with the augmentation.

### TECHNICAL FIELD

Examples of the present disclosure relate generally to remote annotation, drawing, and navigation between extended reality (XR) wearable devices and computing devices. More particularly, but not by way of limitation, examples of the present disclosure relate to an XR wearable device capturing an image of a scene, determining three-dimensional (3D) world coordinates for the scene, and enabling a user of a computing device to add annotations and drawings to the 3D world of the user of the AR wearable device.

### BACKGROUND

XR wearable devices are becoming ubiquitous. Additionally, users increasingly want to be able to operate the XR wearable devices securely with little effort on the part of the user. But often it is difficult to operate the XR wearable devices securely and to make them easily accessible to the users.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram showing an example interaction system for facilitating interactions (e.g., exchanging text messages, conducting text audio and video calls, or playing games) over a network.

FIG. 2 is a block diagram illustrating further details regarding the interaction system 100, according to some examples.

FIG. 3 is a schematic diagram illustrating data structures, which may be stored in the database of the interaction server system, according to certain examples.

FIG. 4 illustrates a system including a head-wearable apparatus with a selector input device, according to some examples.

FIG. 5 is a diagrammatic representation of the machine within which instructions (e.g., software, a program, an application, an applet, an app, or other executable code) for causing the machine to perform any one or more of the methodologies discussed herein may be executed.

FIG. 6 is a block diagram illustrating a software architecture, which can be installed on any one or more of the devices described herein.

FIG. 7 is a perspective view of a head-wearable apparatus in the form of glasses, in accordance with some examples.

FIG. 8 illustrates a system for remote presence on an XR device, in accordance with some examples.

FIG. 9 illustrates a system for remote presence on an XR device, in accordance with some examples.

FIG. 10 illustrates a computing device for remote presence on an XR device, in accordance with some examples.

FIG. 11 illustrates an XR wearable device for remote presence on an XR device, in accordance with some examples.

FIG. 12 illustrates a user view of an XR device, in accordance with some examples.

FIG. 13 illustrates a user view of an XR device, in accordance with some examples.

FIG. 14 illustrates a user view of an XR device, in accordance with some examples.

FIG. 15 illustrates a placement of menu items, in accordance with some example.

FIG. 16 illustrates a method for remote presence on an XR device, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Augmented reality (AR), mixed reality (MR), virtual reality (VR), and/or XR wearable devices, which collectively will be referred to as XR wearable devices, are becoming ubiquitous and often users of the XR wearable devices would like to communicate with remote users where the communication is contextualized to what the user of the XR wearable device sees.

One challenge is how to enable a remote user of a computing device to assist the user of the XR wearable device. This presents several technical challenges. Enabling a remote user to assist another user of an XR device, which encompasses VR, AR, and MR, can lead to a waste of resources in several ways. Firstly, the process often requires a continuous live feed or data stream from the XR device to the remote user's device. This constant transmission consumes significant bandwidth and can strain network resources, especially if the data being transmitted is of high fidelity, which is common with XR content to maintain immersion. The need for high-speed, low-latency connections to facilitate real-time assistance further amplifies the demand on network infrastructure.

Moreover, the remote assistance setup typically involves additional software or platforms to enable communication and control sharing between the XR device and the remote user's device. This can lead to increased computational load on the servers hosting these services, as well as on the devices themselves. The XR device must not only run its own complex applications but also handle the overhead of the remote assistance connection, which can lead to reduced performance, increased power consumption, and quicker battery depletion. From a human resource perspective, providing real-time assistance to XR device users can be labor-intensive. It requires trained personnel to be available to guide users, which can be inefficient, particularly if the demand for assistance is unpredictable or if the issues encountered could be resolved through better user interface design or automated help systems.

These challenges are addressed by the XR wearable device streaming images captured by image capturing devices of the XR wearable device to the computing device. The images enable the remote user to see what the user of the XR wearable device is seeing. This is accomplished by capturing images of the user view of the real-world and by providing display parameters of a display of the XR wearable device to the computing device of the remote user. While viewing the real-time feed of images from the XR wearable device, the remote user can add augmentations. Additionally, a window, which may be termed an insert window, displaying images of the remote user is displayed to the user of the XR wearable device. The inset window is placed near augmentations, such as an arrow or question mark, generated by the remote user and located within a three-dimensional (3D) world coordinate space of the XR wearable device. The perspective of the augmentations and insert window are adjusted to make them appear to be located within the 3D world coordinate space.

The user of the XR wearable device can then receive assistance with a task that has a physicality without being distracted from other tasks. For example, if a remote user was helping the user to learn how to make coffee, the annotations and insert window may be located near the coffee maker. The user of the XR wearable device could turn their head and attend to a child and the annotations and insert window would not be visible. Moreover, the placement of the insert window within the 3D world coordinate space and near the annotations enables the user to see the remote user while focusing on the instructive annotations.

Additionally, in some examples, user interface items are displayed to appear at near field or far field locations where both eyes can resolve the user interface items. Moreover, a user interface item is added to make it easier for the user or remote user to adjust the Z location of an augmentation. The Z location is a position away from or toward the AR wearable device.

The XR wearable device either determines 3D world coordinates for images or provides images for another device to determine 3D coordinates. The remote user's computing device uses the 3D world coordinates to enable the remote user to place the augmentations within the real world of the user of the XR wearable device. In some examples, the XR wearable device determines the 3D world coordinates for only one or a limited number of images. This enables the XR wearable device to reduce the energy necessary to provide the ability for the remote user to add augmentations to the real world of the user of the XR wearable device.

### Networked Computing Environment

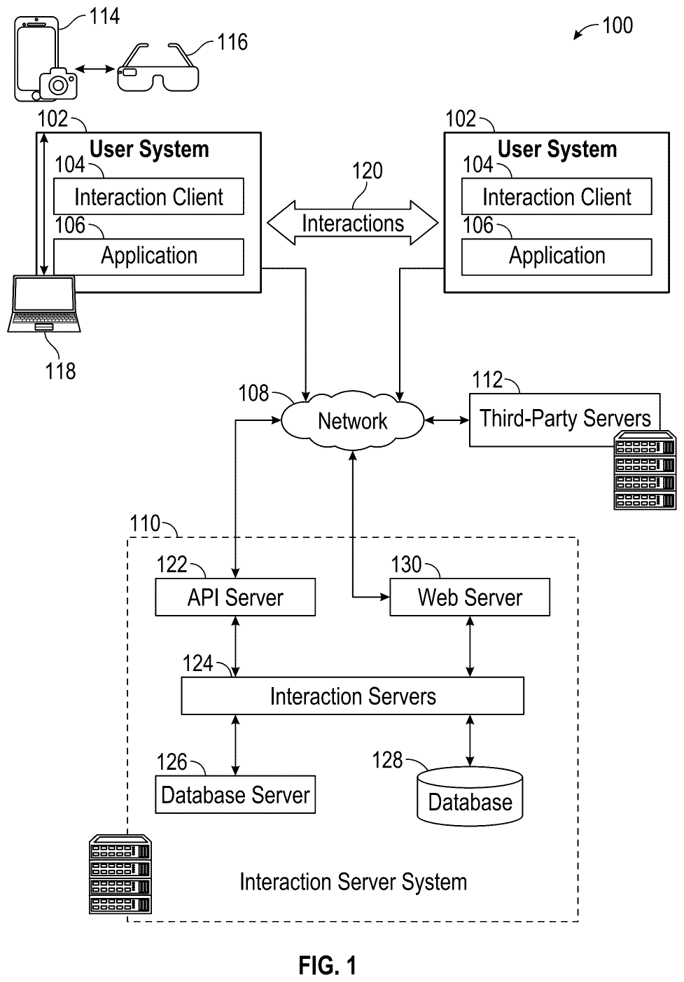

FIG. 1 is a block diagram showing an example interaction system 100 for facilitating interactions (e.g., exchanging text messages, conducting text audio and video calls, or playing games) over a network. The interaction system 100 includes multiple client systems, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems), an interaction server system 110 and third-party servers 112). An interaction client 104 can also communicate with locally hosted applications 106 using Applications Program Interfaces (APIs).

Each user system 102 may include multiple user devices, such as a computing device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

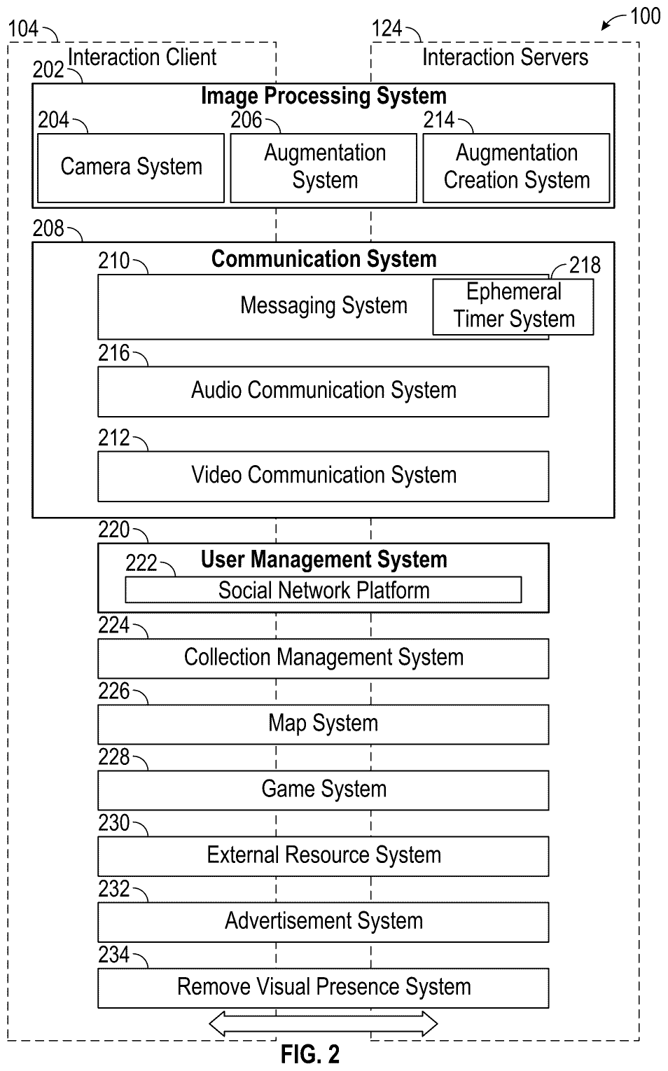

The Application Program Interface (API) server 122 receives and transmits interaction data (e.g., commands and message payloads) between the interaction servers 124 and the client systems (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104). The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 506 of a user system 102. These augmentations are selected by the augmentation system 206 and presented to a user of an interaction client 104, based on a number of inputs and data, such as for example: Geolocation of the user system 102; and Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes an interaction platform that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

A map system 226 provides various geographic location functions and supports the presentation of map-based media content and messages by the interaction client 104. For example, the map system 226 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 228 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 230 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 232 operationally enables the purchasing of advertisements by third parties for presentation to end-users via the interaction clients 104 and also handles the delivery and presentation of these advertisements.

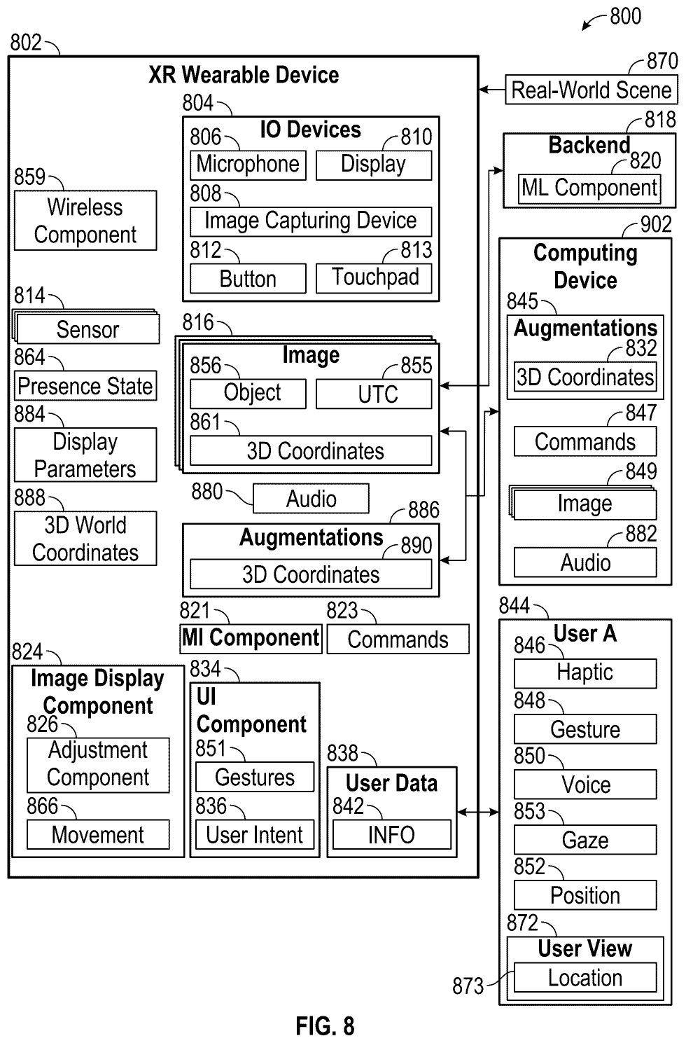

The remote presence system 234 supports or is similar to the system 800 for remote presence on an XR device of FIG. 8. In some examples, the remote presence system 234 performs one or more functions for the XR wearable device 802, the computing device 902, the ML component 820, and so forth. The remote presence system 234 interacts with the social interaction platform 222 by providing services such as providing the user account of the user A 844 of the XR wearable device to the social interaction platform 222.

### Data Architecture

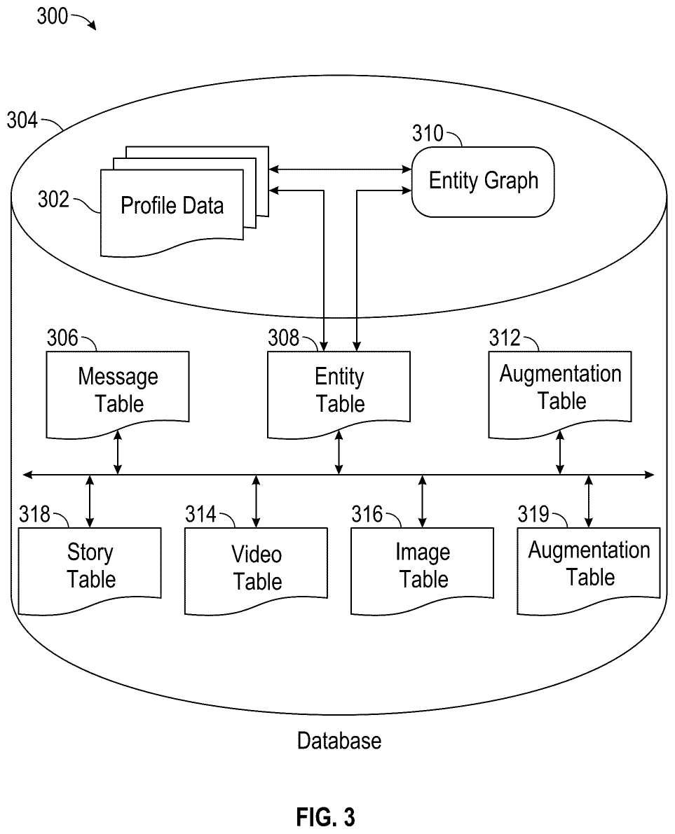

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

The databases 304 also includes augmentation table 319. The augmentation table 319 includes, referring to FIG. 8, augmentations 886, information (info) 842, gestures 851, and so forth. The XR wearable device 802 may retrieve gestures 851, augmentations 886, an application to perform the functions of the remote presence on an XR device, and/or the info 842 from the augmentation table 319.

System with Head-Wearable Apparatus

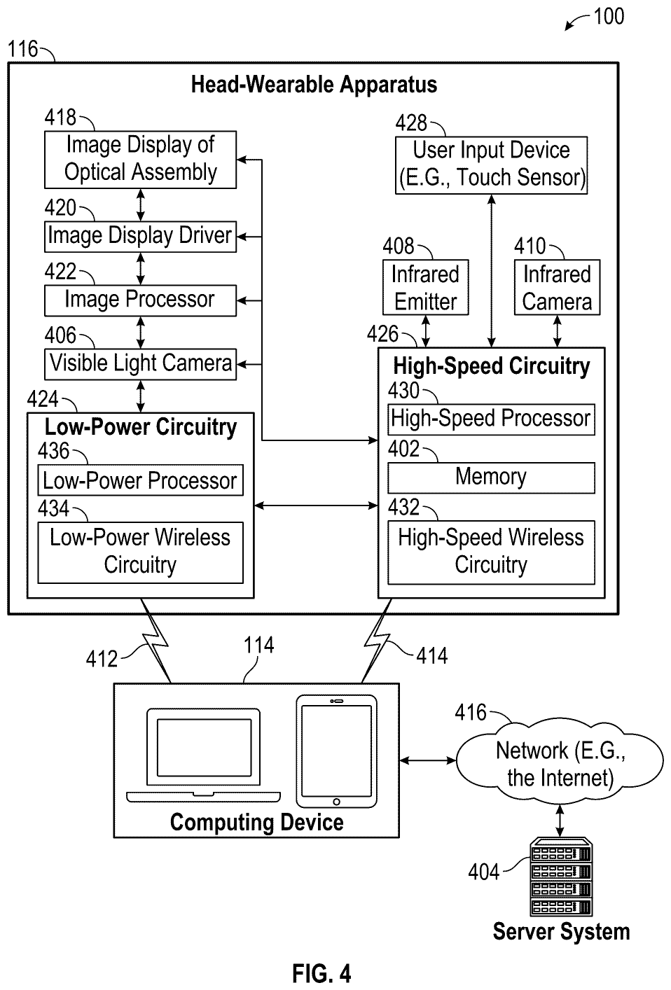

FIG. 4 illustrates a system 400 including a head-wearable apparatus 116 with a selector input device, according to some examples. FIG. 4 is a high-level functional block diagram of an example head-wearable apparatus 116 communicatively coupled to a computing device 114 and various server systems 404 (e.g., the interaction server system 110) via various networks 108.

The head-wearable apparatus 116 includes one or more cameras, each of which may be, for example, a visible light camera 406, an infrared emitter 408, and an infrared camera 410.

The computing device 114 connects with head-wearable apparatus 116 using both a low-power wireless connection 412 and a high-speed wireless connection 414. The computing device 114 is also connected to the server system 404 and the network 416, in accordance with some examples. The computing device 114 may be a portable computing device such as a smart phone, tablet, laptop, or another type of computing device 114 such as a desktop computer, or another type of computing device 114.

The head-wearable apparatus 116 further includes two image displays of the image display of optical assembly 418. The two image displays of optical assembly 418 include one associated with the left lateral side and one associated with the right lateral side of the head-wearable apparatus 116. The head-wearable apparatus 116 also includes an image display driver 420, an image processor 422, low-power circuitry 424, and high-speed circuitry 426. The image display of optical assembly 418 is for presenting images and videos, including an image that can include a graphical user interface to a user of the head-wearable apparatus 116.

The image display driver 420 commands and controls the image display of optical assembly 418. The image display driver 420 may deliver image data directly to the image display of optical assembly 418 for presentation or may convert the image data into a signal or data format suitable for delivery to the image display device. For example, the image data may be video data formatted according to compression formats, such as H.264 (MPEG-4 Part 10), HEVC, Theora, Dirac, Real Video RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 428 (e.g., touch sensor or push button), including an input surface on the head-wearable apparatus 116. The user input device 428 (e.g., touch sensor or push button) is to receive from the user an input selection to manipulate the graphical user interface of the presented image.

The components shown in FIG. 4 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 406 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 402, which stores instructions to perform a subset or all of the functions described herein. The memory 402 can also include storage device.

As shown in FIG. 4, the high-speed circuitry 426 includes a high-speed processor 430, a memory 402, and high-speed wireless circuitry 432. In some examples, the image display driver 420 is coupled to the high-speed circuitry 426 and operated by the high-speed processor 430 in order to drive the left and right image displays of the image display of optical assembly 418. The high-speed processor 430 may be any processor capable of managing high-speed communications and operation of any general computing system needed for the head-wearable apparatus 116. The high-speed processor 430 includes processing resources needed for managing high-speed data transfers on a high-speed wireless connection 414 to a wireless local area network (WLAN) using the high-speed wireless circuitry 432. In certain examples, the high-speed processor 430 executes an operating system such as a LINUX operating system or other such operating system of the head-wearable apparatus 116, and the operating system is stored in the memory 402 for execution. In addition to any other responsibilities, the high-speed processor 430 executing a software architecture for the head-wearable apparatus 116 is used to manage data transfers with high-speed wireless circuitry 432. In certain examples, the high-speed wireless circuitry 432 is configured to implement Institute of Electrical and Electronic Engineers (IEEE) 802.11 communication standards, also referred to herein as WiFi. In some examples, other high-speed communications standards may be implemented by the high-speed wireless circuitry 432.

The low-power wireless circuitry 434 and the high-speed wireless circuitry 432 of the head-wearable apparatus 116 can include short-range transceivers (Bluetooth™) and wireless wide, local, or wide area network transceivers (e.g., cellular or WiFi). Computing device 114, including the transceivers communicating via the low-power wireless connection 412 and the high-speed wireless connection 414, may be implemented using details of the architecture of the head-wearable apparatus 116, as can other elements of the network 416.

The memory 402 includes any storage device capable of storing various data and applications, including, among other things, camera data generated by the left and right visible light cameras 406, the infrared camera 410, and the image processor 422, as well as images generated for display by the image display driver 420 on the image displays of the image display of optical assembly 418. While the memory 402 is shown as integrated with high-speed circuitry 426, in some examples, the memory 402 may be an independent standalone element of the head-wearable apparatus 116. In certain such examples, electrical routing lines may provide a connection through a chip that includes the high-speed processor 430 from the image processor 422 or the low-power processor 436 to the memory 402. In some examples, the high-speed processor 430 may manage addressing of the memory 402 such that the low-power processor 436 will boot the high-speed processor 430 any time that a read or write operation involving memory 402 is needed.

As shown in FIG. 4, the low-power processor 436 or high-speed processor 430 of the head-wearable apparatus 116 can be coupled to the camera (visible light camera 406, infrared emitter 408, or infrared camera 410), the image display driver 420, the user input device 428 (e.g., touch sensor or push button), and the memory 402.

The head-wearable apparatus 116 is connected to a host computer. For example, the head-wearable apparatus 116 is paired with the computing device 114 via the high-speed wireless connection 414 or connected to the server system 404 via the network 416. The server system 404 may be one or more computing devices as part of a service or network computing system, for example, that includes a processor, a memory, and network communication interface to communicate over the network 416 with the computing device 114 and the head-wearable apparatus 116.

The computing device 114 includes a processor and a network communication interface coupled to the processor. The network communication interface allows for communication over the network 416, low-power wireless connection 412, or high-speed wireless connection 414. Computing device 114 can further store at least portions of the instructions for generating binaural audio content in the computing device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 420. The output components of the head-wearable apparatus 116 further include acoustic components (e.g., speakers), haptic components (e.g., a vibratory motor), other signal generators, and so forth. The input components of the head-wearable apparatus 116, the computing device 114, and server system 404, such as the user input device 428, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 412 and high-speed wireless connection 414 from the computing device 114 via the low-power wireless circuitry 434 or high-speed wireless circuitry 432.

### Machine Architecture

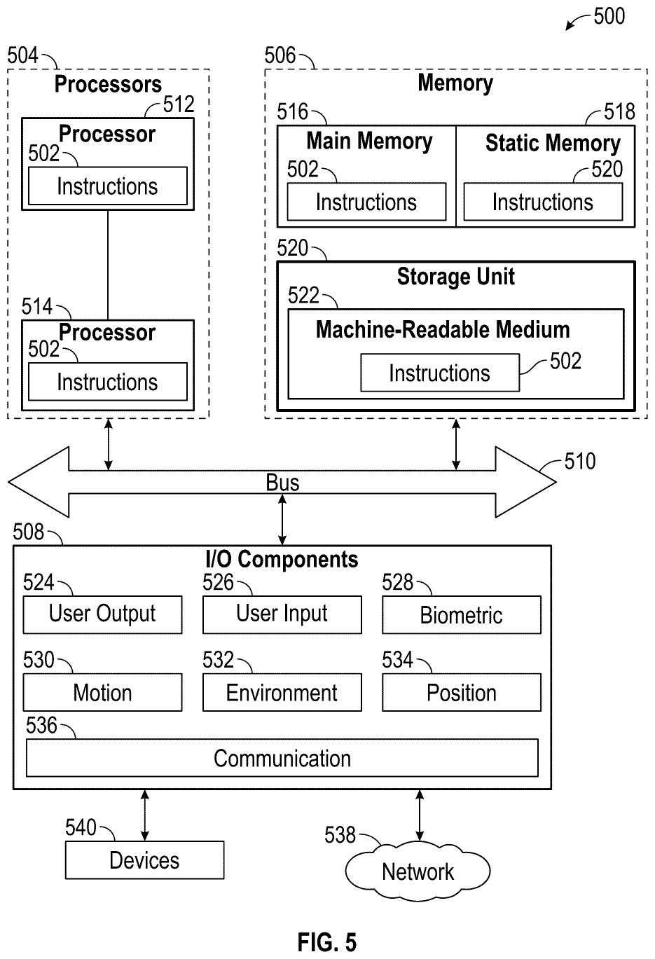

FIG. 5 is a diagrammatic representation of the machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the methods described herein. The instructions 502 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, may comprise the user system 102 or any one of multiple server devices forming part of the interaction server system 110. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 508, which may be configured to communicate with each other via a bus 510. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 512 and a processor 514 that execute the instructions 502. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 516, a static memory 518, and a storage unit 520, both accessible to the processors 504 via the bus 510. The main memory 506, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 may include biometric components 528, motion components 530, environmental components 532, or position components 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 534 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a USB).

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

### Software Architecture

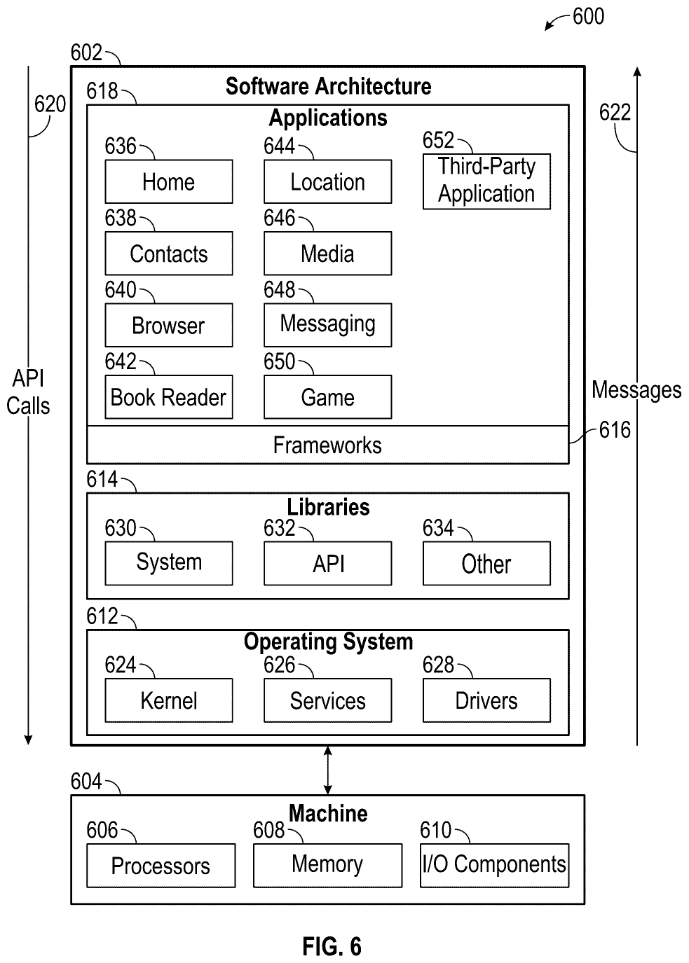

FIG. 6 is a block diagram 600 illustrating a software architecture 602, which can be installed on any one or more of the devices described herein. The software architecture 602 is supported by hardware such as a machine 604 that includes processors 606, memory 608, and I/O components 610. In this example, the software architecture 602 can be conceptualized as a stack of layers, where each layer provides a particular functionality. The software architecture 602 includes layers such as an operating system 612, libraries 614, frameworks 616, and applications 618. Operationally, the applications 618 invoke API calls 620 through the software stack and receive messages 622 in response to the API calls 620.

The operating system 612 manages hardware resources and provides common services. The operating system 612 includes, for example, a kernel 624, services 626, and drivers 628. The kernel 624 acts as an abstraction layer between the hardware and the other software layers. For example, the kernel 624 provides memory management, processor management (e.g., scheduling), component management, networking, and security settings, among other functionalities. The services 626 can provide other common services for the other software layers. The drivers 628 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 614 provide a common low-level infrastructure used by the applications 618. The libraries 614 can include system libraries 630 (e.g., C standard library) that provide functions such as memory allocation functions, string manipulation functions, mathematic functions, and the like. In addition, the libraries 614 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 614 can also include a wide variety of other libraries 634 to provide many other APIs to the applications 618.

The frameworks 616 provide a common high-level infrastructure that is used by the applications 618. For example, the frameworks 616 provide various graphical user interface (GUI) functions, high-level resource management, and high-level location services. The frameworks 616 can provide a broad spectrum of other APIs that can be used by the applications 618, some of which may be specific to a particular operating system or platform.

In an example, the applications 618 may include a home application 636, a contacts application 638, a browser application 640, a book reader application 642, a location application 644, a media application 646, a messaging application 648, a game application 650, and a broad assortment of other applications such as a third-party application 652. The applications 618 are programs that execute functions defined in the programs. Various programming languages can be employed to create one or more of the applications 618, structured in a variety of manners, such as object-oriented programming languages (e.g., Objective-C, Java, or C++) or procedural programming languages (e.g., C or assembly language). In a specific example, the third-party application 652 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 652 can invoke the API calls 620 provided by the operating system 612 to facilitate functionalities described herein.

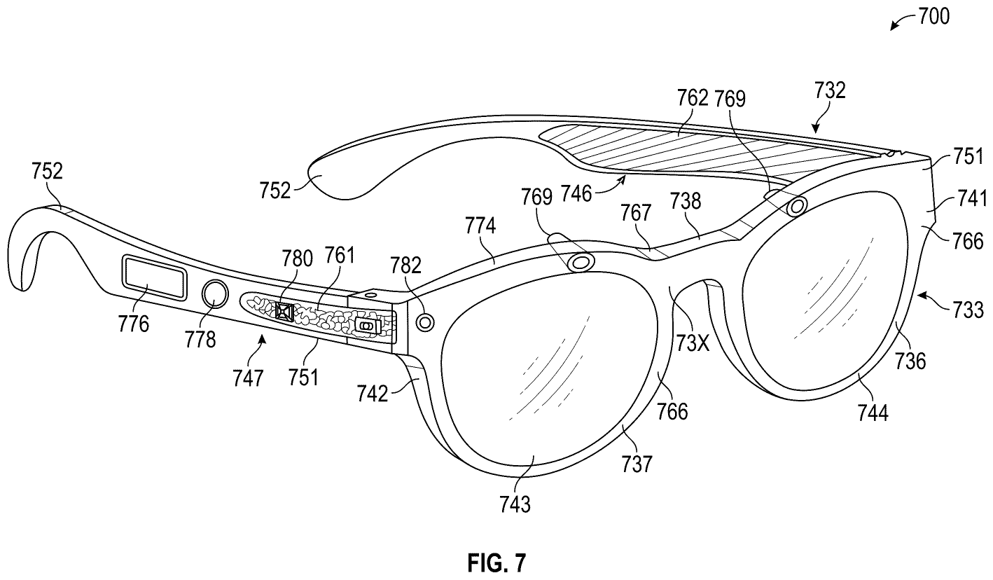

FIG. 7 is a perspective view of a head-wearable apparatus in the form of glasses 700, in accordance with some examples. The glasses 700 are an article of eyewear including electronics, which operate within a network system for communicating image and video content. FIG. 7 illustrates an example of the head-wearable apparatus 116. In some examples, the wearable electronic device is termed augmented reality (AR), mixed reality (MR), virtual reality (VR), and/or extended reality (XR) glasses. The glasses 700 can include a frame 732 made from any suitable material such as plastic or metal, including any suitable shape memory alloy. The frame 732 can have a front piece 733 that can include a first or left lens, display, or optical element holder 736 and a second or right lens, display, or optical element holder 737 connected by a bridge 738. The front piece 733 additionally includes a left end portion 741 and a right end portion 742. A first or left optical element 744 and a second or right optical element 743 can be provided within respective left and right optical element holders 736, 737. Each of the optical elements 743, 744 can be a lens, a display, a display assembly, or a combination of the foregoing. In some examples, for example, the glasses 700 are provided with an integrated near-eye display mechanism that enables, for example, display to the user of preview images for visual media captured by cameras 769 of the glasses 700.

The frame 732 additionally includes a left arm or temple piece 746 and a right arm or temple piece 747 coupled to the respective left and right end portions 741, 742 of the front piece 733 by any suitable means such as a hinge (not shown), so as to be coupled to the front piece 733, or rigidly or fixedly secured to the front piece 733 so as to be integral with the front piece 733. Each of the temple pieces 746 and 747 can include a first portion 751 that is coupled to the respective end portion 741 or 742 of the front piece 733 and any suitable second portion 752, such as a curved or arcuate piece, for coupling to the ear of the user. In one example, the front piece 733 can be formed from a single piece of material, so as to have a unitary or integral construction. In one example, the entire frame 732 can be formed from a single piece of material so as to have a unitary or integral construction.

The glasses 700 include a computing device, such as a computer 761, which can be of any suitable type so as to be carried by the frame 732 and, in one example, of a suitable size and shape, so as to be at least partially disposed in one or more of the temple pieces 746 and 747. In one example, the computer 761 has a size and shape similar to the size and shape of one of the temple pieces 746, 747 and is thus disposed almost entirely if not entirely within the structure and confines of such temple pieces 746 and 747.

In one example, the computer 761 can be disposed in both of the temple pieces 746, 747. The computer 761 can include one or more processors with memory, wireless communication circuitry, and a power source. The computer 761 comprises low-power circuitry, high-speed circuitry, location circuitry, and a display processor. Various other examples may include these elements in different configurations or integrated together in different ways. Additional details of aspects of the computer 761 may be implemented as described with reference to the description that follows.

The computer 761 additionally includes a battery 762 or other suitable portable power supply. In one example, the battery 762 is disposed in one of the temple pieces 746 or 747. In the glasses 700 shown in FIG. 7, the battery 762 is shown as being disposed in the left temple piece 746 and electrically coupled using a connection 774 to the remainder of the computer 761 disposed in the right temple piece 747. One or more input and output devices can include a connector or port (not shown) suitable for charging a battery 762 accessible from the outside of the frame 732, a wireless receiver, transmitter, or transceiver (not shown), or a combination of such devices.

The glasses 700 include digital cameras 769. Although two cameras 769 are depicted, other examples contemplate the use of a single or additional (i.e., more than two) cameras 769. For ease of description, various features relating to the cameras 769 will be described further with reference to only a single camera 769, but it will be appreciated that these features can apply, in suitable examples, to both cameras 769.

In various examples, the glasses 700 may include any number of input sensors or peripheral devices in addition to the cameras 769. The front piece 733 is provided with an outward-facing, forward-facing, front, or outer surface 766 that faces forward or away from the user when the glasses 700 are mounted on the face of the user, and an opposite inward-facing, rearward-facing, rear, or inner surface 767 that faces the face of the user when the glasses 700 are mounted on the face of the user. Such sensors can include inward-facing video sensors or digital imaging components such as cameras 769 that can be mounted on or provided within the inner surface 767 of the front piece 733 or elsewhere on the frame 732 so as to be facing the user, and outward-facing video sensors or digital imaging components such as the cameras 769 that can be mounted on or provided with the outer surface 766 of the front piece 733 or elsewhere on the frame 732 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 743, 744 (or lenses) to provide a mixed reality or augmented reality experience for the user of the glasses 700.

The glasses 700 further include an example of a camera control mechanism or user input mechanism comprising a camera control button mounted on the frame 732 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 732 adjacent to its surface for detecting the presence of a user's finger, to dispose the touch-sensitive button to the engaged condition when the user touches a finger to the corresponding spot on the outer surface 766 of the frame 732. It will be appreciated that the above-described camera control button and capacitive touch button are but two examples of a haptic input mechanism for single-action control of the camera 769, and that other examples may employ different single-action haptic control arrangements.

The computer 761 is configured to perform the methods described herein. In some examples, the computer 761 is coupled to one or more antennas for reception of signals from a GNSS and circuitry for processing the signals where the antennas and circuitry are housed in the glasses 700. In some examples, the computer 761 is coupled to one or more wireless antennas and circuitry for transmitting and receiving wireless signals where the antennas and circuitry are housed in the glasses 700. In some examples, there are multiple sets of antennas and circuitry housed in the glasses 700. In some examples, the antennas and circuitry are configured to operate in accordance with a communication protocol such as Bluetooth™, Low-energy Bluetooth™, IEEE 802, IEEE 802.11az/be, WiFI®, and so forth. In some examples, PDR sensors housed in glasses 700 and coupled to the computer 761. In some examples, the glasses 700 are VR headsets where optical elements 743, 744 are opaque screens for displaying images to a user of the VR headset. In some examples, the computer 761 is coupled to user interface elements such as slide or touchpad 776 and button 778. A long press of button 778 resets the glasses 700. The slide or touchpad 776 and button 778 are used for a user to provide input to the computer 761 and/or other electronic components of the glasses 700. The glasses 700 include one or more microphones 782 that are coupled to the computer 761. The glasses 700 include one or more gyroscopes 780.

### Remote Presence on an XR Device

FIG. 8 illustrates a system 800 for remote presence on an XR device, in accordance with some examples. The system 800 includes an XR wearable device 802 such as the glasses 700 of FIG. 7 or the head-wearable apparatus 116 of FIGS. 1 and 4. Additionally, referring to FIGS. 1, 2, and 9, one or more other devices such as the interaction server system 110, the user system 102, the remote presence system 234, and/or the computing device 902 may perform one or more of the functions or operations described herein.

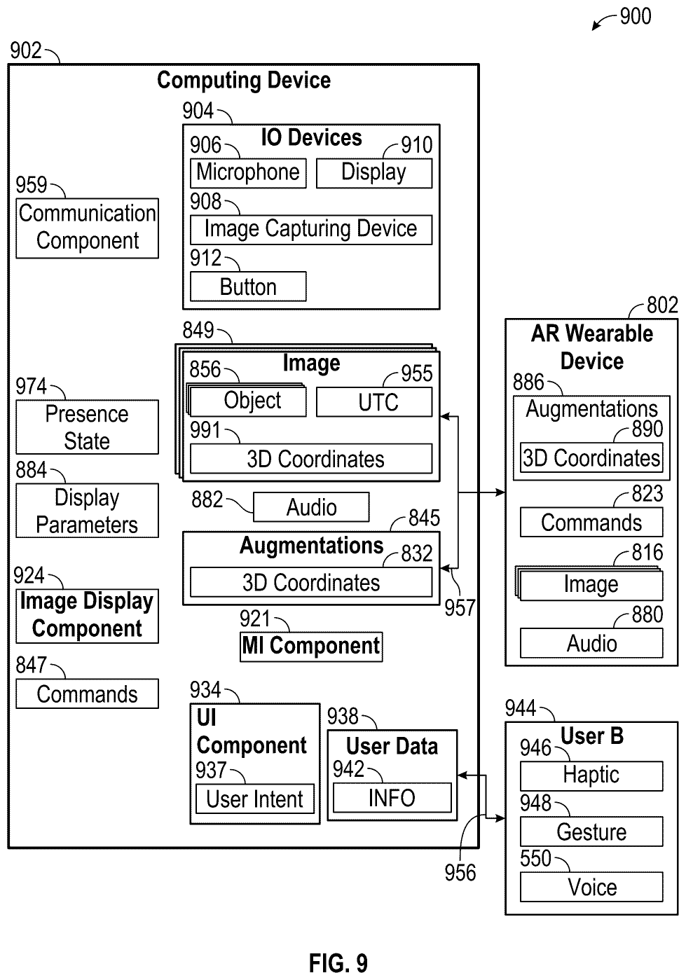

The XR wearable device 802 interacts with the computing device 902 of FIG. 9. The XR wearable device 802 sends audio 880, images 816, which may include 3D coordinates 861 and, optionally, commands 823, audio 880, augmentations 886 with 3D coordinates 890 to the computing device 902. The computing device 702 sends commands 847, images 849, audio 882, and augmentations 786 with 3D coordinates 832 to the XR wearable device 802.

The input/output (IO) devices 804 include devices that enable user A 844 to receive output or provide input to the system 800. The IO devices 804 include a microphone 806, a display 810, a speaker (not illustrated), one or more image capturing devices 808, one or more buttons 812, a touchpad 813, a gyroscope (not illustrated), and so forth. The image capturing devices 808 capture the images 816 of the real-world scene 870 which is a front facing view of a user view 872, which is what the user A 844 sees through the XR wearable device 802, in accordance with some examples. The image capturing devices 808 may capture other views such as a rear view of what user A 844 see or a view of user A 844.

The location 873 is 3D coordinates within a 3D world coordinates 888 system that indicates a location of the user view 872. The image capturing devices 808 may be charged-coupled device (CCD) or another type of device to capture an image of the real-world scene 870. Button 778 and touchpad 776 of FIG. 7 are examples of the button 812 and the touchpad 813, respectively. The button 812 and touchpad 813 enable the user A 844 to provide haptic 846 input. The microphone 806 enables the user A 844 to provide voice 850 input and to generate the audio 880. The image capturing devices 808 enables the user A 844 to provide gesture 848 input via the user interface (UI) component 834, which processes or analyzes the images 816 to determine the user intent 836 based on gestures 848 performed by the user A 844.

Some devices such as a gyroscope can be both a sensor 814 and an IO device 804. For example, the user A 844 may move the XR wearable device 802, which changes the position 852 of the user A 844 and communicates input to the XR wearable device 802. The position of user A 844 is assumed to be the same as the XR wearable device 802, in accordance with some examples. The XR wearable device 802 detects the change in position 852 using a sensor 814 such as a gyroscope or another change of position sensor to detect the change of position 852 of the user A 844. The movement of the user A 844 may have a user intent 836 to communicate input to the XR wearable device 802 such as a gesture 848. However, the user A 844 may move with the XR wearable device 802 without a user intent 836 to communicate input to the XR wearable device 802.

The sensors 814 includes a gyroscope, light sensor, a positioning sensor, a clock, and so forth. The clock (not illustrated) generates the Coordinated Universal Time (UTC) 855. The wireless component 859 communicates 854, 857, with the backend 818 and/or the computing device 902. The wireless component 859 is configured to perform wireless communication protocols, with the computing device 902, the backend 818, and/or intermediate devices, where the communication protocols include Bluetooth Low Energy® (BLE), Institute for Electrical and Electronic Engineers (IEEE) 802.11 communication protocols, proprietary communications protocols, 3GPP communication protocols, and so forth. The wireless component 859 sets up a wireless communication link between the XR wearable device 802 and the computing device 902, the backend 818, and/or intermediate devices. For example, the wireless component 859 associates with a corresponding communications component 959 on the computing device 902 and/or backend 818. The wireless component 859 may communicate with the computing device 902 and/or the backend 818 via another intermediate device such as a user system 102, which may also be the backend 818, an access point, or a node B. For example, the wireless component 859 couples with the user system 102 such as a smart phone using BLE and the user system 102 uses IEEE 802.11 or 3GPP to communicate via the internet with the computing device 902. In some examples, the wireless component 859 can be used to determine a location and/or an orientation of the XR wearable device 802 with the assistance of other wireless devices.

The presence state 864 is stored in a memory of the XR wearable device 802 and indicates whether a presence state 864 is “on” or “off”. The presence state 864 is a state where the XR wearable device 802 and computing device 902 communicate with one another for remote presence as discussed herein. The presence state 864 may only be entered if the XR wearable device 802 and computing device 902 have an established video connection or a similar connection, in accordance with some example. The presence state 864 is changed based on input from user A 844 and user B 944. User A 844 or user B 944 may request that the presence state 864 be entered. The XR wearable device 802 or the computing device 902 will contact the other device and request that the presence state 864 be entered. In some examples, the XR wearable device 802 or the computing device 902 can enter the presence state 864 without the consent of the other device.

In some examples, the image display component 824 receives a request to enter the presence state 864 from the computing device 902. The image display component 824 queries the user A 844 whether the user A 844 wants to enter the presence state 864. Similarly, the image display component 924 of FIG. 9 of the computing device 902 may receive a request to enter the presence state 864 from the XR wearable device 802. In some examples, the presence state 864 has two states of “on” and “off.”

If the presence state 864 is “on”, then the image display component 824 causes the image capturing device 808 to begin capturing images 816. In some examples, an existing image 816 may be used by the image display component 824 if the images 816 are already being captured. For example, the XR wearable device 802 and computing device 902 may already have an active video connection.

In some examples, there are multiple image-capturing devices 808 and the image display component 824 selects one or more image capturing devices 808 that are front looking or that cover the real-world scene 870 as seen by the user A 844 through, for example, the glasses 700 and is denoted as the user view 872. In some examples, the images 816 include more than the user view 872. For example, the images 816 may provide a 360-degree view of the real-world scene 870 or a view of a face of the user A 844.

The image display component 824 causes the images 816 to be sent or streamed to the computing device 902. In some examples, an image 816 is sent to the computing device 902 and then the XR wearable device 802, refrains from sending a next image 816 to the computing device 902 if the computing device 902 sends a command 847 to pause sending the images 816. The image display component 824 includes or associates a UTC 855 with each of the images 816, or another type of identification is associated with each of the images 816. Additionally, the image display component 824 sends display parameters 884 to the computing device 902, in accordance with some examples. The display parameters 884 enable the computing device 902 to simulate or determine how to present the display 810 of the XR wearable device 802. The display parameters 884 includes an aspect ratio, a screen resolution, and so forth. The images 816 are stored in a memory of the XR wearable device 802 for a buffer period such as a number of seconds such as 5 to 100 seconds. In some examples, image display component 824 causes audio 880 to be captured by the microphone 806 and to be sent or streamed simultaneously with the images 816. The audio 880 may be streamed as part of a video connection or another similar type of connection. The image display component 824 synchronizes the audio 880 and the images 816.

In some examples, the image display component 824 sends augmentations 886 with 3D coordinates 890 of augmentations that are created by user A 844. In some examples, the augmentations 886 do not include 3D coordinates 890 and are intended to be displayed on the display 910 of the computing device while the images 816 are being displayed as a video. In some examples, the augmentations 886 include augmentations generated by the XR wearable device 802 such as labels for objects 856. In some examples, image display component 824 incorporates the augmentations 886 into the images 816 so that the images 816 represent what is displayed on the display 810 of the XR wearable device 802.

The image display component 824 responds to commands 847 received from the computing device 902 and causes the audio 882 to be played on a speaker of the XR wearable device 802. The image display component 824 responds to a command 847 from the computing device 902 indicating that the computing device 902 is requesting that 3D coordinates 861 be sent for an image 816 with a UTC 855. The image display component 824 uses the machine learning (ML) component 821 or sends the image 816 to the ML component 820 of the backend 818 to process the image 816 to generate the 3D coordinates 861 and, in some examples, the objects 856 of the image 816.

The ML component 821 and ML component 820 are configured to operate in accordance with Visual Inertial Odometry (VIO) to determine the 3D world coordinates 888 system, in accordance with some examples. In some examples, ML component 821 and ML component 820 operate by using other computer vision or machine learning techniques such as deep learning to identify the objects 856. The 3D coordinates 861 are in a 3D world coordinate 888 system for the XR wearable device 802, in accordance with some examples. In some examples, the XR wearable device 802 determines the 3D world coordinates 888 for images 816 that are being sent to the computing device 902. Determining the 3D world coordinates 888 may be processor intensive so reducing the areas in which 3D world coordinates 888 are determined reduce the demands on the battery of the XR wearable device 802. In some examples, the 3D coordinates 861 are in a 3D coordinate system relative to a position of the XR wearable device 802.

In some examples, the 3D coordinates 861 are a point cloud where 3D positions are indicated for x and y positions within the image 816. Once the 3D coordinates 861 for the image 816 are determined, the image display component 824 sends the 3D coordinates 861 to the computing device 902. The computing device 902 sends augmentations 845 to the XR wearable device 802 with a command 847 for the augmentations 845 to be displayed on the displayed 810 or for the augmentations 845 to be added to the 3D world coordinates 888 of the XR wearable device 802. The commands 847 may include selections of objects 856 and to highlight an object 856. The commands 847 may include where to place the images 849 from the computing device 902 on the display 810 of the XR wearable device 902.

The image display component 824 processes augmentations 845 and augmentations 886 and displays them on the display 810 for the user A 844 to view in conjunction with viewing the user view 872 of the real-world scene 870. The augmentations 886 may be generated on the XR wearable device 802 by the user A 844. The augmentations 886 and augmentations 845 added to the 3D world coordinate 888 system of the XR wearable device may not be visible depending on the current user view 872. The augmentations 886 and augmentations 845 may not be visible or may be partially obscured by other objects. For example, if an augmentation 845 is added on tabletop behind a coffee maker, then the augmentation 845 will only be visible to the user A 844 if the user view 872 includes a view of behind the coffee maker.

The adjustment component 826 projects or adjusts the augmentations 886 and augmentations 845 to be in a proper perspective for the location 873 of the user view 872. For example, the size and angle of a line is adjusted in accordance with how far away from the XR wearable device 802 an augmentation 886 or augmentation 845 is. The placement of the augmentations 686 and augmentations 886 are based on the 3D coordinates 832 and 3D coordinates 890, respectively, within the 3D world coordinates 888 system. The augmentations 845 and augmentations 886 may be AR graphics.

The augmentations 845 and augmentation 886 may fade after being generated. For example, the augmentations 845 and augmentations 886 may fade gradually to disappear in 10 to 60 seconds. In some examples, the augmentation 886 is displayed using a first brightness and after a predetermined duration, the augmentation 886 is displayed using a second brightness, where the second brightness is less than the first brightness. The brightness of the augmentation 886 may continue to be decreased in increments such as 20% with each decrease. The augmentation 886 may then either be deleted or not displayed if the brightness goes to zero or below.

In some examples, the augmentations 845 and augmentations 886 may be selected and moved. For example, on the computing device 902 a press and hold on an augmentation 845 or an augmentation 886 selects the augmentation 845 or an augmentation 886 and enables the user B 944 to move the augmentation 845 or the augmentation 886. On the XR wearable device 802 the user A 844 may select the augmentation 845 or the augmentation 886 using, for example, a haptic 846 by hovering their finger over the augmentation 845 or an augmentation 886. Reducing the size of augmentation 845, 886 may move the augmentation 845, 886 backward from the XR wearable device 802, which may be termed changing a Z coordinate of the augmentation 845, 886.

The term AR graphics includes anything displayed by the XR wearable device 802 on the display 810 for the user A 844 to view in conjunction with viewing the real world through the lenses. Alternatively, the user A 844 may view the real world by the XR wearable device 802 capturing images 816 and displaying the images 816 and the AR graphics on an opaque display 810. The augmentations 845 and augmentations 886 include graphics that are displayed on the display 810 such as coloring an object 856 to indicate it has been selected and displaying the images 849 from the computing device 902. The images 849 may be of the face of the user B 944.

The 3D world coordinates 888 system is coordinates within the real-world scene 870 and are determined by the ML component 821 or ML component 820. The 3D world coordinates 888 system may be constructed and updated over time as the ML component 821 or ML component 820 process images 816 and/or use location 873 data. The ML component 820 may be ML component 921 performing the operations. For example, the XR wearable device 802 may send the images 816 and location 873 information to the computing device 902, which may perform the processing and send back augmentations 845 to be displayed on the display 810 of the XR wearable device 802.

In some examples, the augmentations 845 or augmentations 886 are not displayed if the 3D coordinates 832 or 3D coordinates 861, respectively, indicate that the augmentations 845 or augmentations 886 would not be visible to the user A 844 based on the location 873 of the user view 872 of the real-world scene 870. For example, user B 944 of FIG. 9 may be helping user A 844 cook and user A 844 may have turned their head to look at a kitchen sink when augmentations 845 are over a stove area.

In some examples, motion sensors 814 are used to determine a movement 866 of the XR wearable device 802. A change of location 873 is then determined based on the movement 866. The augmentations 886 and augmentations 845 can be moved a number of pixels based on the movement 866 of the XR wearable device 802, in accordance with some examples. The image display component 824 can display the augmentations 886 and augmentations 845 based on the 3D coordinates 890 and 3D coordinates 832, respectively, and the location 873 of the user view 872. The 3D coordinates 861, 832 and location 873 are 3D coordinates within the 3D world coordinate 888 system.

In some examples, if the augmentations 886 or augmentations 845 are not visible within the user view 872, then the image display component 824 displays an indication on the display 810 that there are augmentations 886 or augmentations 845 that have not been viewed or currently are not within the user view 872. In some examples, the image display component 824 determines a direction the user A 844 would have to travel to be able to see the augmentations 886 or augmentations 845 and displays an indication of the direction on the display 810.

Additionally, the image display component 824 responds to a command 847 to display the augmentations 886 or augmentations 845 on the display 810 in real time. The augmentations 886 or augmentations 845 may be drawings or directions such as a left or right arrow. The image display component 824 displays the augmentations 886 or augmentations 845 for a period of time on the display 810 or, in some examples, until receiving a command 847 or command 823 to delete the augmentations 886 or the augmentations 845.

The UI component 834 processes input from the IO devices 804 to determine a user intent 836 from the user data 838, which is collected based on actions of or information determined from the user A 844. For example, the UI component 834 determines whether it was the user intent 836 to turn the presence state 864 “on” or “off.” The UI component 834 offers or displays user interface items such as menus of options for generating augmentations 845. A user intent 836 may generate a command 823 such as to draw an augmentation 886. The command 823 may include to send augmentations 886 and other data to the computing device 902. In some example, both the user A 844 and the user B 944 can generate augmentations. The UI component 834 enables user A 844 to add augmentations 886 such as by drawing with their finger in the air. The user A 844 may make selections using a gesture 848 such as a movement of their finger. The UI component 834 analyzes the movement of the finger by analyzing images 816 captured over time. The UI component 834 may determine or estimate a gaze 853 location of the user A 844. The UI component 834 identifies a gesture 848 performed by the user A 844 based on stored gestures 851. The gestures 851 may be to add augmentations 886 such as a question mark.

The user data 838 is data that is related to the user A 844. The information (info) 842 includes additional information about the user A 844 such as a social media account to log onto the social network platform 222, a username, a display icon for the user A 844, and so forth.

FIG. 9 illustrates a system 900 for remote presences on an XR device, in accordance with some examples. The system 900 includes a computing device 902 such as the computing device 902, the interaction system 100 of FIG. 2, the computing device 114 of FIG. 4, a desktop computer, a laptop computer, a tablet, the XR wearable device 802, or another computing device. Additionally, referring to FIGS. 1, 2, and 9, one or more other devices such as the interaction server system 110, the user system 102, remote presence system 234, and/or the XR wearable device 802 may perform one or more of the operations described herein.

The computing device 902 interacts with the XR wearable device 802. The XR wearable device 802 sends audio 880, images 816, augmentations 886, commands 823, and so forth, to the computing device 702. The input/output (IO) devices 904 include devices that enable user B 944 to receive output or provide input to the system 900. The IO devices 904 include a microphone 906, a display 910, a speaker (not illustrated), one or more image capturing devices 908, buttons 912, and so forth. The image capturing devices 908 capture the images 816 to provide haptic 946 input. For example, the image display component 924 may identify a gesture 948 performed by the user B 944. The microphone 906 enables the computing device 902 to capture audio 882 data to send to the XR wearable device 802 and to provide voice 950 input.

The communications component 959 communicates 956, 957 with the XR wearable device 802, a backend 818 of FIG. 8, and other devices. The communications component 959 is configured to perform wireless communication protocols, with the XR wearable device 802 and/or an intermediate device, where the communication protocols include Bluetooth® Low Energy (BLE), Institute for Electrical and Electronic Engineers (IEEE) 802.11 communication protocols, proprietary communications protocols, 3GPP communication protocols, and so forth. The communications component 959 sets up a wired or wireless communication link between the XR wearable device 802 and the computing device 902, the backend 818, and/or an intermediate device. For example, the communications component 959 associates with a corresponding wireless component 859 on the XR wearable device 802. The communications component 959 may communicate with the XR wearable device 802 via intermediate devices such as an access point, or a node B. For example, the computing device 902 may communicate with an access point or node B, which communicates with the interaction server system 110, which communicates with the XR wearable device 802 via the internet and, optionally, a computing device 902. In some examples, the communication component 959 can be used to determine a location and/or an orientation of the computing device 902 with the assistance of other wireless devices.

The presence state 974 is stored in a memory of the computing device 902 and indicates a state of the presence state 974 as being “on” or “off”. The presence state 974 is a state where the XR wearable device 802 and computing device 902 communicate with one another for remote annotation and navigation as discussed herein. The presence state 974 is changed based on input from user B 944 and user A 844. User A 844 or user B 944 may request that the presence state 974 be entered or set to a value of “on”. The XR wearable device 802 or the computing device 902 will contact the other device and request that the presence state 974 be entered. In some examples, the image display component 924 receives a request to enter the presence state 974 from the XR wearable device 802. The image display component 924 queries the user B 944 whether the user B 944 wants to enter the presence state 974. Similarly, the image display component 924 of the XR wearable device 802 may receive a request to enter the presence state 974 from the computing device 902. In some examples, the presence state 974 has two states of “on” and “off.”

If the presence state 974 is “on”, then the image display component 924 accesses the images 816 received from the XR wearable device 802 and displays them on the display 910 for consumption of the user B 944. The display parameters 884 are received from the XR wearable device 802 or from a configuration operation. The image display component 924 uses the display parameters 884 to simulate or emulate the display 810 of the XR wearable device 802 to display the images 816 on the display 910, in accordance with some examples. The user B 944 then sees the images 816 on display 910 in a same way as the user A 844 does on display 810.

The image display component 924 plays the audio 880 received from the XR wearable device 802 simultaneously with the images 816. The presence state 974 may only be entered if the XR wearable device 802 and the computing device 902 are in an active telephone call, in accordance with some example. Additionally, the image display component 924 captures audio 882 from the microphone 906 and streams the audio 882 to the XR wearable device 802.

The UI component 934 processes input from the IO devices 904 to determine a user intent 937 from the user B 944. For example, the UI component 934 determines whether it was the user intent 937 to turn the presence state 974 “on” or “off.” The UI component 934 offers or displays UI items such as menus of options for the selection of commands 847 such as to add augmentations 845. The UI component 934 enables the user B 944 to add augmentations 845 such as by the user B 944 drawing augmentations 845 using their finger in the air, a mouse, a touchscreen, selecting or drawing a geometric shape or line, or some other method. In some examples, when the objects 856 are identified, the UI component 934 recognizes a user intent 937 to select an object 856 and the augmentation 845 is a highlighting of the object 856. The UI component 934 additionally provides the functionality described in conjunction with UI component 834 of FIG. 8 such as for gestures 851.

The user data 938 is data that is related to the user B 944. The information (info) 942 may include additional information about the user B 944 such as a social media account to log onto the interaction server system 110 or social network platform 222, a username, a display icon, and so forth.

The image display component 924 displays the augmentations 886 from the XR wearable device 802 with the images 816 and the augmentations 845 generated by the computing device 902. In some examples, the augmentations 886 include an identification such as a UTC to indicate that the augmentation 886 should be displayed with one or more particular images 816. Augmentations 886 and augmentations 845 have 3D coordinates 890 and 3D coordinates 991, respectively. The 3D coordinates 890 and 3D coordinates 991 may indicate a place on the display 810, 910 rather than 3D coordinates 890, 991 within the 3D world coordinates 888, in accordance with some examples. In some examples, the 3D coordinates 890, 991 are determined by the XR wearable device 802 or computing device 902 based on determining which 3D world coordinate 888 is closest to a pixel of the augmentation 886, 845, within the image 816 or user view 872.

The image display component 924 responds to commands 823 from the user B 944. In response to the user B 944 generating an augmentation 845, the image display component 924 sends the augmentation 845 to the XR wearable device 802 for the XR wearable device 802 to display the augmentation 845 on the display 810. The augmentation 845 may be a highlight of an object 856, a direction, a highlight arrow, a free form drawing, or another augmentation. The augmentation 845 may include an UTC 955 to indicate which image 816 or images 849 the augmentation 845 was added to. The 3D coordinates 991 may be determined by the image display component 924 during generation of the augmentation 845 using 3D world coordinates 888 as described in conjunction with the XR wearable device 802. The image display component 924 may use the ML component 921 or another ML component such as ML component 820 or ML component 821 to assist in determining the user intent 937 of where to place the augmentations 845 within the 3D world coordinates 888.

As the images 816 are displayed on the display 910, the user B 944 may indicate a user intent 937 corresponding to a command 847 of “Edit”. The image display component 924 responds to the command “Edit” by displaying the selected image 816 that was being played on the display 910 when the “Edit” command 847 was selected by the user B 944. This enables the user B 944 to “Edit” the image 816 without the user A 844 having to remain still so that the images 816 would display the same user view 872. The image 816 is displayed in a simulated display of display 810 of the XR wearable device 802 using the display parameters 884 on the display 910. The image display component 924 may continue to receive and play images 816, in a separate window, from the XR wearable device 802, which may be termed a live feed of what user A 844 is seeing. In some examples, the user B 944 can pause the stream of images 816 so the user B 944 can add the augmentation 845 without the movement of user A 844. The add annotations 1012 menu, another menu, or pressing the display 910 may include a pause option.

The image display component 924 then sends the UTC 855 of an image 816 or another identification to the XR wearable device 802. The XR wearable device 802 responds with 3D coordinates 861 of the selected image 816. In some examples, the 3D coordinates 861 are sent with the images 816, so the image display component 924 does not have to send the UTC 855 to the XR wearable device 802.

The ML component 921 determines the 3D coordinates 832 for the augmentations 845. The following is an example of determining the 3D coordinates 832 of augmentations 845 in accordance with a user intent 937. The ML component 921 uses the 3D coordinates 861 received for an image 816 to determine the 3D coordinates 832 of augmentations 845 that are added by the user B 944. In some examples, the 3D coordinates 861 are a point cloud where 3D positions are indicated for x, y, and z positions within the image 816. The ML component 921 associates the augmentations 845 added by the user B 944 with coordinates on the display 910 which is simulating the display 810. The coordinates of the augmentations 845 on the display 910 are then matched with the point cloud to determine the 3D coordinates 832 for the augmentation 845. The UI component 934 may offer the user B 944 the option of controlling a Z value, which is a distance from the display 910 or the user A 844, while the user B 944 is placing the augmentations 845. The UI component 934 determines, based on currently determined 3D coordinates for the augmentation 845 and the indication to move the augmentation 845, which is either forward or backward, new 3D coordinates for the augmentation 845.

In some examples, the XR wearable device 802 sends object 856 information with the 3D coordinates 861 of the selected image 816 or other information that may be used by the ML component 921 to determine the 3D coordinates 832 of the augmentations 845 for an object 856. The ML component 921 uses the object 856 information, which may include for each object 856 an indication of the area of the image 816 occupied by object 856, and 3D coordinates 861 for the object 856.

The ML component 921 may determine the 3D coordinates 832 of the augmentations 845 based on relationships of the objects 856 with the augmentations 845. For example, if an object 856 is encircled by a free form drawing around the object 856, the ML component 921 gives the augmentation 845 3D coordinates 832 that place the augmentation 845 around the object 856. In some examples, the objects 856 are surfaces of the image 816 and the ML component 921 determines the 3D coordinates 832 based on the relationship of the augmentations 845 with the surfaces, which are represented by 3D coordinates. In some examples, the augmentations 845 are display 810, 910 augmentations 845 which are to be displayed on the displays 810, 910 with no 3D coordinates 832. For example, user B 944 may write an augmentation 845 of “Hi” that is to be displayed on the display 810 for consumption by user A 844.

After the ML component 921 determines the 3D coordinates 832 of the augmentations 845, the image display component 924 sends the indications of the augmentations 845 with the 3D coordinates 832 to the XR wearable device 802. The XR wearable device 802 adds the augmentations 845 to its 3D world coordinates 888. The image display component 924 may close a window opened for the selected image 816 based on a timeout or based on a command by the user B 944. In some examples, the image display component 924 determines the 3D coordinates 832 of the augmentations 845 in accordance with the user intent 937 based on a continuing stream of images 816. For example, the image display component 924 determines initial 3D coordinates 832 for an augmentation 845 based on a current image 816 and the display 910 continues to display the stream of images 816. If the initial 3D coordinates 832 are not visible, then an arrow may indicate the direction of the augmentation 845. User B 944 may have to request that user A 844 adjust the user view 872 to make the augmentation 845 visible in the display 910 so user B 944 can finish the augmentation 845.

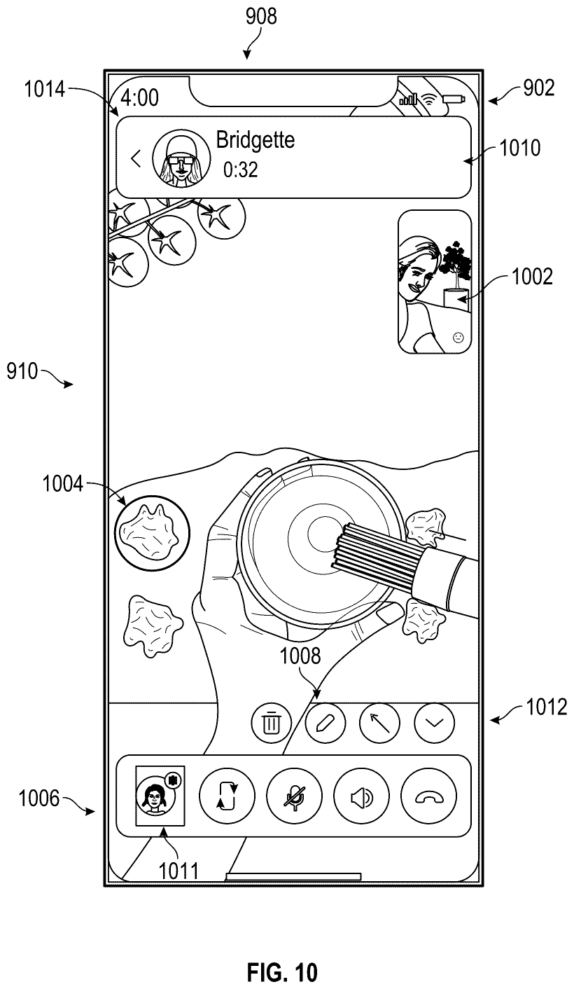

FIG. 10 illustrates a computing device 902 for remote presence, in accordance with some examples. The computing device 902 is the same or similar as the computing device 902 of FIG. 9. The following refers to FIGS. 8, 9, and 10. The video insert 1002 is from a front facing image capturing device 908. The video insert 1002 shows “Jaz”, the person in the video insert 1002, the images 849 the computing device 902 is sending to the XR wearable device 802. The video insert 1002 may include one or more menu items. For example, the video insert 1002 may be dismissed. The video insert 1002 may be tilted. The video insert 1002 may indicate where the video insert 1002 is being presented to user A 844, “Bridgette.” The video insert 1002 may be placed in a particular position within the 3D world coordinates 888 of the XR wearable device 802. For example, “Jaz” may move the video insert 1002 and have it anchored to the augmentation 1004. Video capture 1011 turns on and off sending the images 849 for the video insert 1002. The video insert 1002 like an augmentation 845 may continue to exist within the 3D world coordinates 888 but not be visible within the current view of user B 944, “Bridgette”. For example, the video insert 1002 may be anchored to the augmentation 1004 and “Bridgette” may turn her head to the sink. The video insert 1002 would then not be visible until “Bridgette” turned her head back to the augmentation 1004. In some examples, the video insert 1002 has a display 910 position and maintains its position on the display 910 independently of the user view 872.

The message 1014 indicates that the display 910 is presenting images 816 from the XR wearable device 802 of user A 844, “Bridgette”. The presence 1010 icon, which may be a bitmoji turns “on” and “off” the presence state 974. The presence 1010 may include one or more menu items. For example, there may be a menu item to stop seeing “Bridgette's View” or change the size of “Bridgette's View”. As illustrated the arrows would minimize “Bridgette's View.”

The augmentation 1004 was generated by user B 944, “Jaz”, the user of the computing device 902. The augmentation 1004 has 3D coordinates 832 so it will only be visible if the 3D coordinates 832 are within the user view 872. The augmentation 1004 may have been added by user B 944, “Jaz”, selecting draw annotation 1008.

The menu items 1006 present options for user B 944, “Jaz”. The video capture 1011 menu item indicates that user B 944, “Jaz”, is “streaming to Bridgette”. The video capture 1011 menu item switches between streaming the video insert 1002 to user A 844, “Bridgette”, and not streaming to user A 844. The menu items 1006 include audio off/on, sound off/on, hang up call, and presence 1010. The presence state 974 may be termed a “mobile presence” state or “remote user presence on an AR device” state. The presence state 974 may be turned “off” by user B 944, “Jaz”, but to turn on the presence state 974 may require user A 844 turning on the presence state 974 to ensure privacy for user A 844. In some examples, the bitmojis for user A 844 and user B 944 may be 3D bitmojis. In some examples, placing an augmentation 1004 includes the option of a Z widget that enables the user B 944 to change the z position of the augmentation 1004. In some examples, user B 944 grabbing using, for example, a touchscreen and reducing the size of the augmentation 1004 will change the Z position of the augmentation 1004. For example, reducing the size of augmentation 1004 may place the augmentation 1004 under the food rather than over the food so the food obscures part of the augmentation 1004 rather than the other way around. The display parameters 884 are used by the computing device 902 to determine how to display the images. For example, an aspect ratio, a number of pixels per inch, and so forth.

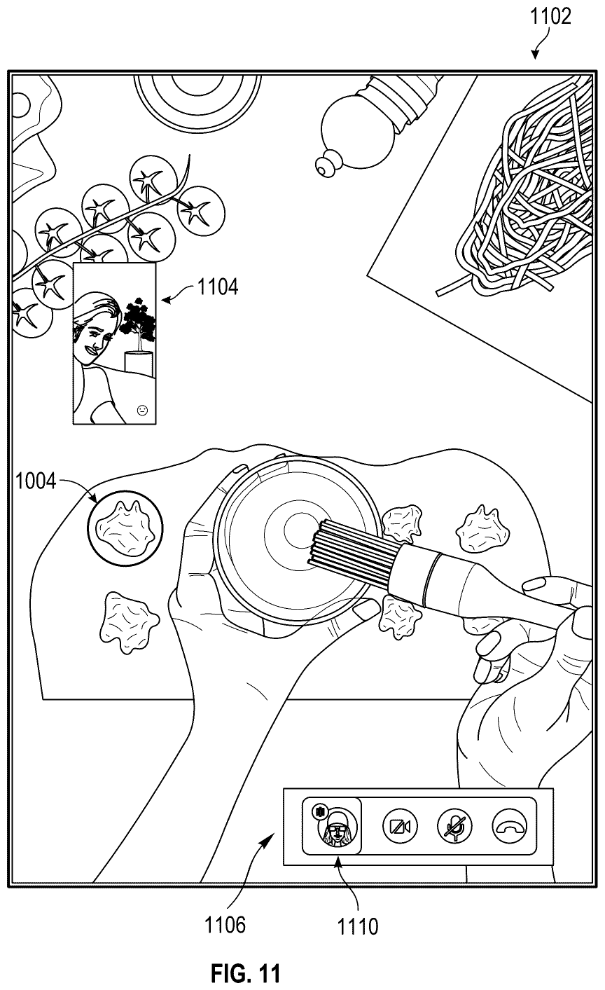

FIG. 11 illustrates an XR wearable device 802 for remote presence on an XR device, in accordance with some examples. The following refers to FIGS. 8-11. The user view 1102 is what user A 844, who is “Bridgette”, sees. The user view 1102 has two parts the user view 872 of the real-world scene 870 and additions from the display 810 that include the augmentation 1004, video insert 1104, and menu items 1106. The video insert 1104 presents images 849 from the computing device 902. As illustrated the video insert 1104 is from a front facing image capturing device 908, which captures the face of user B 944, who is “Jaz.” The video insert 1104 may have 3D coordinates within the 3D world coordinates 888 of the XR wearable device 802 such as being placed above the augmentation 1004. The video insert 1104 size then changes as user A 844 moves around the real-world scene 870. The video insert 1104 may have a fixed orientation or may float to point towards user A 844. For example, the video insert 1104 may have an orientation that is perpendicular to the tabletop and above the augmentation 1004. The video insert 1104 is then presented on the display 810 in accordance with its properties. The video insert 1002 of FIG. 10 may have different properties than the video insert 1104. For example, the video insert 1104 may be anchored to a 3D coordinate within the 3D world coordinates of the XR wearable device 802 while the video insert 1002 may be anchored to a position on the display 910 so user B 944 can see what they are streaming to user A 844.

The augmentation 1004 is an augmentation 845 with a 3D coordinate 832 within the 3D world coordinates 888 of the XR wearable device 802. The XR wearable device 802 may share the 3D world coordinates 888 with the computing device 902 to assist the computing device 902 in determining the 3D coordinates 832 for the augmentations 845. Processing the augmentations 845 and video insert 1002 may be performed by the image display component 824, which may utilize ML component 821, ML component 820, and/or ML component 921. In some examples, the computing device 902 performs the processing to ingrate the augmentation 1004 and video insert 1002, and the computing device 902 sends processed images to the XR wearable device 802 to display on the display 810.

The menu items 1106 include a menu item presence 1110 that indicates user B 944, “Jaz”, is streaming to user A 844, “Bridgette.” The menu items 1106 include menu items to turn “off” the video, turn “off” the sound, hang up the videocall, and the menu item presence 1110 state. Selecting the menu item presence 1110 would stop the streaming from user B 944, “Jaz” and close the video insert 1104. Initially, selecting the menu item presence 1110 creates the video insert 1104. In some examples, the video insert 1104 may be images 849 of something other than user B 944 such as an instruction video that user B 944 is streaming to user A 844. In some examples, there may be multiple video inserts 1104.

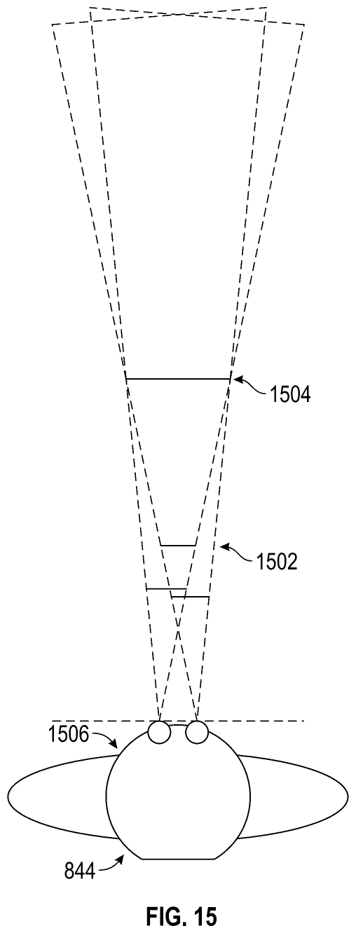

In some examples, when menu item 1110 is selected, the video insert 1104 is created and the menu items 1106 readjusts to three menu items. For example, the menu items 1106 become three buttons wide, where the change may be animated. The three buttons may be the menu items 1106 to turn “off” the video, turn “off” the sound, hang up the videocall. The number of menu items 1106 is reduced to lessen the visual distraction of the menu items 1106. In some examples, the menu items 1106 has at least two states. A reduced state and an expanded state. In some examples, the reduced state has three menu items 1106 and the expanded state has four or more menu items 1106. The user A 844 may be provided a menu item to change the menu items 1106 between the reduced state and the expanded state. In some examples, the width of the menu items 1106 is determined based on the position of the menu items 1106 such as, referring to FIG. 15, at the near field 1502 or at the far field 1504. In some examples, the menu items 1106 is three or four buttons and the menu items 1106 are positioned at or approximately at the near field 1502 or at or approximately at the far field 1504.

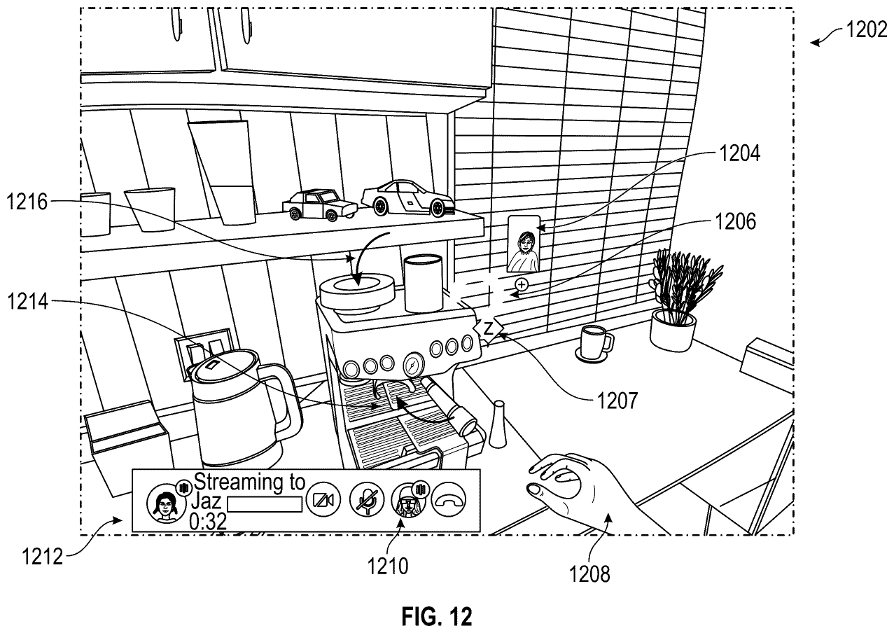

FIG. 12 illustrates a user view 1202 for remote presence on an XR device, in accordance with some examples. The user A 844 is seeing the user view 1202 with the XR wearable device 802. The hand 1208 of user A 844 is visible. The following refers to FIGS. 8, 9, and 12. The user A 844 drew augmentation (aug) C 1206 using their hand 1208 on the XR wearable device 802. The user A 844 may have performed a gesture 848, given a voice 850 command, or selected a menu item to initiate drawing the aug C 1206. Aug C 1206 is an example of an augmentation 886 that is generated by the XR wearable device 802. In some examples, the image display component 824 determined the user intent 836 to draw an augmentation 886 based on the drawing of a question mark by a finger of the hand 1208.

The presence 1210 icon can be used to turn “on” and “off” the presence state 864. Menu items 1212 provides various menu items that user A 844 may select and indicates that user A 844 is currently streaming to user B 944, who is “Jaz”. The video insert 1204 indicates a video of user B 944 or “Jaz.” The video insert 1204 was placed near aug A 1216 and aug B 1214 by the image display component 824 and sized as to not be intrusive to the objects 856 within the user view 872. User B 944 generated aug A 1216 and aug B 1214 on the computing device 902 as augmentations 845, and the computing device 902 sent them to the XR wearable device 802.

The example illustrated in FIG. 12 is user A 844 called user B 944 with remote presence. User A 844 drew aug C 1206 and asked user B 944 how to operate the coffee maker. User B 944 verbally explained how to use the coffee maker and drew aug A 1216 and aug B 1214 to supplement the explanation. In some examples, the video insert 1204 is placed over the bitmoji of “Jaz”. The Z 1207 is another menu item. The Z 1207 enables the user A 844 or user B 944 to move the augmentation 886, which here is aug C 1206, in the Z direction, which brings the augmentation 886 either closer or farther away from the user A 844.

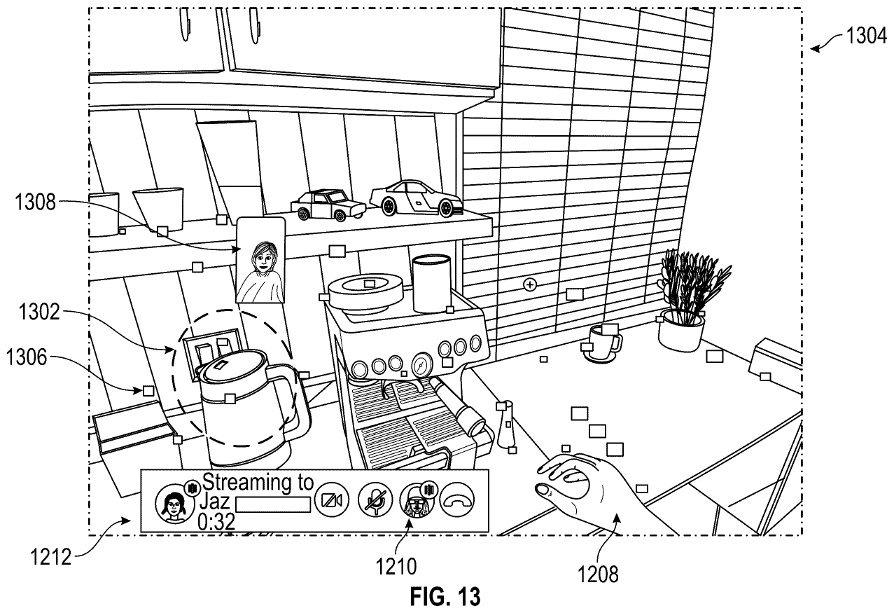

FIG. 13 illustrates a user view 1304 for remote presence on an XR device, in accordance with some examples. The user A 844 is seeing the user view 1304 with the XR wearable device 802 of FIG. 8, which includes the real-world scene 870 and the display 810. The hand 1208 of user A 844 is visible. Augmentation D 1302 was received from the computing device 902. The 3D coordinates 1306 illustrate 3D world coordinates 888, which may have been determined by the ML component 821, by analyzing one or more images 816. The 3D coordinates 1306 may be determined in other ways. The 3D coordinates 1306 each have an x, y, and z component within the 3D world coordinates 888. In some examples, the location of augmentations is determined based on their proximity to the 3D coordinates 1306.

The video insert 1308 has been placed behind and above the object 856 selected by augmentation D 1302 and sized in accordance with the 3D coordinate where the video insert 1308 has been placed. In some examples, eye tracking is used to determine where the user A 844 is looking and the video insert 1308 is placed in this location or near the location so that user A 844 may view both the video insert 1308 and focus on the task that user A 844 is performing.

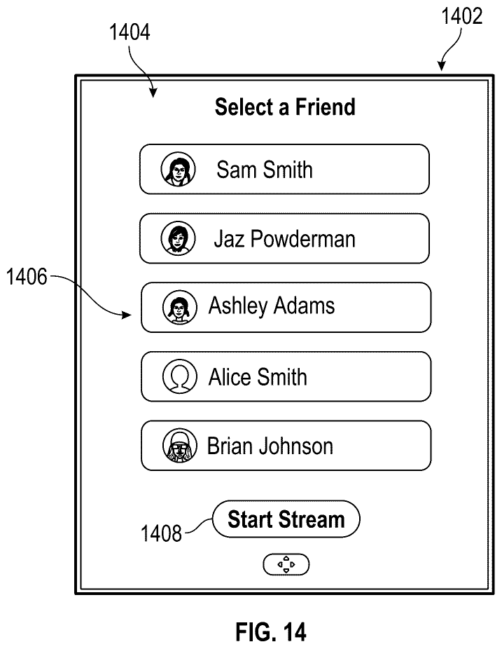

FIG. 14 illustrates a user view 1402 for remote presence on an XR device, in accordance with some examples. The user A 844 is seeing a menu 1404 of friends 1406 to select a friend 1406 for a remote presence session. The menu 1404 is a scrollable list. The “start stream” menu item attempts to connect with the selected friend 1406. The friends 1406 may be friends within the social network platform 222.

If a friend has not selected a bitmoji then a placeholder is used. The friends may be loaded from contacts of user A 844. In some examples, the menu 1404 appears approximately 30 to 50 cm away from the user A 844 and centered in the user view 872.

In some examples, the menu 1404 is positioned at a human arm distance so that the menu 1404 is reachable for direct hand interactions and visible within the device's field of view. The menu 1404 follow's the user motion and is additionally movable by the user to be positioned where it is comfortable.

In some examples, the XR wearable device 802, rather than using a touch interface to control virtual content interactions (or in addition to using the touch interface) uses front-facing cameras that can track the user's hands in real time via computer vision technologies. The eyewear device 119 can then control interactions with the virtual content such as menu 1404 based on positioning of the user's hands and gestures performed by the hands. FIG. 15 illustrates a placement of menu items, in accordance with some examples. The user A 844 is wearing XR wearable device 802. The image display component 824 of FIG. 8, in some examples, displays menu items on the display 810 to appear either in a near field 1502 or a far field 1504. The near field 1502 is approximately 45 cm and is where both eyes can resolve a menu item into a single overlapping range. The far field 1504 is approximately 110 cm and is in a second place where both eyes can resolve a menu item into a single overlapping range.

The display images overlap at the focal plane 1504 but have a narrower overlap near to the user. In some examples, the menus used such as menu items 1106 are designed to be narrow, so they are comfortable near the user at or approximately at near field 1502. At or approximately at the near field 1502, the user is able to reach out and pinch the menu items such as the buttons of menu items 1106 directly. A narrow layout such as menu items 1106 with three or four buttons accomplishes this goal and fits at near field 1502. Wider menus such as menu items 1212 of FIGS. 12 and 13 need to be positioned at focal plane 504 in order to be both legible, visually comfortable and interactive.

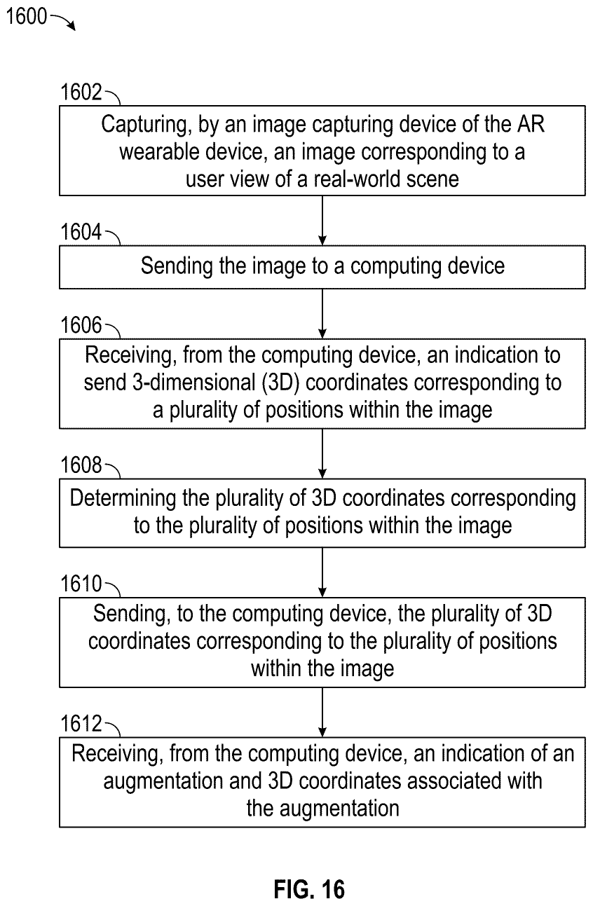

FIG. 16 illustrates a method 1600 for remote presence on an XR device, in accordance with some examples. The method 1600 begins at operation 1602 with capturing, by an image capturing device of the XR wearable device, an image corresponding to a user view of a real-world scene. For example, image capturing device 808 of FIG. 8 captures an image 816 of the user view 872 of the real-world scene 870.

The method 1600 continues at operation 1604 with sending the image to a computing device. For example, the XR wearable device 802 sends the image 816 to the computing device 902.

The method 1600 continues at operation 1606 with receiving, from the computing device, an indication to send 3D coordinates corresponding to a plurality of positions within the image. For example, computing device 902 sends a command 847 to send 3D coordinates to the XR wearable device 802.

The method 1600 continues at operation 1608 with determining the plurality of 3D coordinates corresponding to the plurality of positions within the image. For example, the ML component 821 or ML component 820 may be used to process the image 816 to determine 3D coordinates.

The method 1600 continues at operation 1610 with sending, to the computing device, the plurality of 3D coordinates corresponding to the plurality of positions within the image. For example, the XR wearable device 802 sends 3D coordinates 861 to the computing device 902.

The method 1600 continues at operation 1612 with receiving, from the computing device, an indication of an augmentation and 3D coordinates associated with the augmentation. For example, the computing device 902 sends the augmentation 845 with the 3D coordinates 832.

The method 1600 optionally includes one or more additional operations, the operations of method 1600 can be performed in a different order, or one or more of the operations of the method 1600 can be optional. The method 1600 may be performed in whole or in part by one or more of the computing devices such as XR wearable device 802, or an apparatus of one or more computing devices disclosed herein. The functions of a component, such as the ML component 821, are performed or executed by one or more computing devices configured to perform or execute the functions of the component.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” or “component” refers, for example, to a device, physical entity, or logic having boundaries defined by function or subroutine calls, branch points, APIs, or other technologies that provide for the partitioning or modularization of particular processing or control functions. Components or components may be combined via their interfaces with other components to carry out a machine process. A component or component may be a packaged functional hardware unit designed for use with other components and a part of a program that usually performs a particular function of related functions. Components or components may constitute either software components (e.g., code embodied on a machine-readable medium) or hardware components. A “hardware component” or “hardware component” is a tangible unit capable of performing certain operations and may be configured or arranged in a certain physical manner. In various examples, one or more computer systems (e.g., a standalone computer system, a client computer system, or a server computer system) or one or more hardware components or software components of a computer system (e.g., a processor or a group of processors) may be configured by software (e.g., an application or application portion) as a hardware component or software component that operates to perform certain operations as described herein. A hardware component or hardware component may also be implemented mechanically, electronically, or any suitable combination thereof. For example, a hardware component hardware component may include dedicated circuitry or logic that is permanently configured to perform certain operations. A hardware component or hardware component may be a special-purpose processor, such as a field-programmable gate array (FPGA) or an application-specific integrated circuit (ASIC). A hardware component or hardware component may also include programmable logic or circuitry that is temporarily configured by software to perform certain operations. For example, a hardware component or hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component or hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components or hardware components can provide information to, and receive information from, other hardware components. Accordingly, the described hardware components or hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component or hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems. Additional claimable subject matter further includes the following:

Example 1 is an extended reality (XR) wearable device comprising: at least one processor; and at least one memory storing instructions that, when executed by the at least one processor, configure the XR wearable device to perform operations comprising: capturing, by an image capturing device of the XR wearable device, an image corresponding to a user view of a real-world scene; sending the image to a computing device; receiving, from the computing device, an indication to send a plurality of three-dimensional (3D) coordinates corresponding to a plurality of positions within the image; determining the plurality of 3D coordinates corresponding to the plurality of positions within the image; sending, to the computing device, the plurality of 3D coordinates corresponding to the plurality of positions within the image; and receiving, from the computing device, an indication of an augmentation and 3D coordinates associated with the augmentation.

In Example 2, the subject matter of Example 1 includes, wherein the operations further comprise: receiving an indication from the computing device to send next images.

In Example 3, the subject matter of Examples 1-2 includes, wherein the operations further comprise: receiving a video stream from the computing device, the video stream comprising a plurality of images captured by an image capturing device of the computing device; and displaying the video stream on a display of the XR wearable device.

In Example 4, the subject matter of Example 3 includes, wherein the displaying further comprises: displaying the video stream in a video insert window, the video insert window positioned near the 3D coordinates of the augmentation.

In Example 5, the subject matter of Examples 3-4 includes, wherein the displaying further comprises: displaying the video stream in a video insert window, the video insert window positioned at a far field location or a near field location of a user of the XR wearable device.

In Example 6, the subject matter of any of Examples 1-5 includes, wherein the operations further comprise: in response to a determination that the user view of a user of the XR wearable device comprises the 3D coordinates associated with the augmentation, displaying the augmentation on a display of the XR wearable device to appear at a location indicated by the 3D coordinates.

In Example 7, the subject matter of any of Examples 1-6 includes, wherein the augmentation is a first augmentation, and wherein the operations further comprise: receiving, from a user of the XR wearable device, an indication of a second augmentation; and determining 3D coordinates for the second augmentation.

In Example 8, the subject matter of Example 7 includes, D world coordinates in a frame of reference of the XR wearable device.

In Example 9, the subject matter of Example 8 includes, wherein the operations further comprise: determining a 3D coordinate of the 3D coordinates for the second augmentation based on a pixel of the second augmentation being closest, within the image, to the 3D coordinate of the plurality of 3D coordinates.

In Example 10, the subject matter of Example 9 includes, D coordinates.

In Example 11, the subject matter of any of Examples 7-10 includes, wherein the operations further comprise: receiving a selection of a user interface item, the user interface item indicating to move the second augmentation back from the user or towards the user; and determining, based on the 3D coordinates and the indication to move the second augmentation, new 3D coordinates for the second augmentation.

In Example 12, the subject matter of any of Examples 1-11 includes, wherein the augmentation is a first augmentation, and wherein the operations further comprise: capturing, by the image capturing device, images corresponding to user views of the real-world scene; processing the images to identify a gesture, the gesture indicating a second augmentation; and determining 3D coordinate for the second augmentation.

In Example 13, the subject matter of any of Examples 1-12 includes, wherein the augmentation is displayed using a first brightness, and wherein the operations further comprise: displaying, after a predetermined duration, the augmentation at a second brightness, wherein the second brightness is less than the first brightness.

In Example 14, the subject matter of any of Examples 1-13 includes, wherein the augmentation comprises a geometric shape or a line drawn by user input.

In Example 15, the subject matter of Examples any of 1-14 includes, wherein the operations further comprise: sending the image to a host computing device with an instruction to determine the plurality of 3D coordinates for the image; and receiving the plurality of 3D coordinates from the host computing device.

Example 16 is a method performed by an extended reality (XR) wearable device, the method comprising: capturing, by an image capturing device of the XR wearable device, an image corresponding to a user view of a real-world scene; sending the image to a computing device; receiving, from the computing device, an indication to send a plurality of 3-dimensional (3D) coordinates corresponding to a plurality of positions within the image; determining the plurality of 3D coordinates corresponding to the plurality of positions within the image; sending, to the computing device, the plurality of 3D coordinates corresponding to the plurality of positions within the image; and receiving, from the computing device, an indication of an augmentation and 3D coordinates associated with the augmentation.

In Example 17, the subject matter of Example 16 includes, receiving an indication from the computing device to send next images.

Example 18 is a non-transitory computer-readable storage medium, the computer-readable storage medium including instructions that when executed by an extended reality (XR) wearable device, cause the XR wearable device to perform operations comprising: capturing, by an image capturing device of the XR wearable device, an image corresponding to a user view of a real-world scene; sending the image to a computing device; receiving, from the computing device, an indication to send a plurality of 3-dimensional (3D) coordinates corresponding to a plurality of positions within the image; determining the plurality of 3D coordinates corresponding to the plurality of positions within the image; sending, to the computing device, the plurality of 3D coordinates corresponding to the plurality of positions within the image; and receiving, from the computing device, an indication of an augmentation and 3D coordinates associated with the augmentation.

In Example 19, the subject matter of Example 18 includes, wherein the operations further comprise: receiving an indication from the computing device to send next images.

In Example 20, the subject matter of Example 19 includes, wherein the operations further comprise: receiving a video stream from the computing device, the video stream comprising a plurality of images captured by an image capturing device of the computing device; and displaying the video stream on a display of the XR wearable device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. An extended reality (XR) wearable device comprising:
at least one processor; and
at least one memory storing instructions that, when executed by the at least one processor, configure the XR wearable device to perform operations comprising:
capturing, by an image capturing device of the XR wearable device, an image corresponding to a user view of a real-world scene;
sending the image to a computing device;
receiving, from the computing device, an indication to send a plurality of three-dimensional (3D) coordinates corresponding to a plurality of positions within the image;
determining the plurality of 3D coordinates corresponding to the plurality of positions within the image;
sending, to the computing device, the plurality of 3D coordinates corresponding to the plurality of positions within the image; and
receiving, from the computing device, an indication of an augmentation and 3D coordinates associated with the augmentation.

2. The XR wearable device of claim 1, wherein the operations further comprise:
receiving an indication from the computing device to send next images.

3. The XR wearable device of claim 1, wherein the operations further comprise:
receiving a video stream from the computing device, the video stream comprising a plurality of images captured by an image capturing device of the computing device; and
displaying the video stream on a display of the XR wearable device.

4. The XR wearable device of claim 3, wherein the displaying further comprises:
displaying the video stream in a video insert window, the video insert window positioned near the 3D coordinates of the augmentation.

5. The XR wearable device of claim 3, wherein the displaying further comprises:
displaying the video stream in a video insert window, the video insert window positioned at a far field location or a near field location of a user of the XR wearable device.

6. The XR wearable device of claim 1, wherein the operations further comprise:
in response to a determination that the user view of a user of the XR wearable device comprises the 3D coordinates associated with the augmentation, displaying the augmentation on a display of the XR wearable device to appear at a location indicated by the 3D coordinates.

7. The XR wearable device of claim 1, wherein the augmentation is a first augmentation, and wherein the operations further comprise:
receiving, from a user of the XR wearable device, an indication of a second augmentation; and
determining 3D coordinates for the second augmentation.

8. The XR wearable device of claim 7, wherein the plurality of 3D coordinates are 3D world coordinates in a frame of reference of the XR wearable device.

9. The XR wearable device of claim 8, wherein the operations further comprise:
determining a 3D coordinate of the 3D coordinates for the second augmentation based on a pixel of the second augmentation being closest, within the image, to the 3D coordinate of the plurality of 3D coordinates.

10. The XR wearable device of claim 9, wherein the plurality of 3D coordinates is a point cloud of 3D coordinates.

11. The XR wearable device of claim 7, wherein the operations further comprise:
receiving a selection of a user interface item, the user interface item indicating to move the second augmentation back from the user or towards the user; and
determining, based on the 3D coordinates and the indication to move the second augmentation, new 3D coordinates for the second augmentation.

12. The XR wearable device of claim 1, wherein the augmentation is a first augmentation, and wherein the operations further comprise:
capturing, by the image capturing device, images corresponding to user views of the real-world scene;
processing the images to identify a gesture, the gesture indicating a second augmentation; and
determining 3D coordinate for the second augmentation.

13. The XR wearable device of claim 1, wherein the augmentation is displayed using a first brightness, and wherein the operations further comprise:
displaying, after a predetermined duration, the augmentation at a second brightness, wherein the second brightness is less than the first brightness.

14. The XR wearable device of claim 1 wherein the augmentation comprises a geometric shape or a line drawn by user input.

15. The XR wearable device of claim 1 wherein the operations further comprise:
sending the image to a host computing device with an instruction to determine the plurality of 3D coordinates for the image; and
receiving the plurality of 3D coordinates from the host computing device.

16. A method performed by an extended reality (XR) wearable device, the method comprising:
capturing, by an image capturing device of the XR wearable device, an image corresponding to a user view of a real-world scene;
sending the image to a computing device;
receiving, from the computing device, an indication to send a plurality of 3-dimensional (3D) coordinates corresponding to a plurality of positions within the image;
determining the plurality of 3D coordinates corresponding to the plurality of positions within the image;
sending, to the computing device, the plurality of 3D coordinates corresponding to the plurality of positions within the image; and
receiving, from the computing device, an indication of an augmentation and 3D coordinates associated with the augmentation.

17. The method of claim 16, further comprising:
receiving an indication from the computing device to send next images.

18. A non-transitory computer-readable storage medium, the computer-readable storage medium including instructions that when executed by an extended reality (XR) wearable device, cause the XR wearable device to perform operations comprising:
capturing, by an image capturing device of the XR wearable device, an image corresponding to a user view of a real-world scene;
sending the image to a computing device;
receiving, from the computing device, an indication to send a plurality of 3-dimensional (3D) coordinates corresponding to a plurality of positions within the image;
determining the plurality of 3D coordinates corresponding to the plurality of positions within the image;
sending, to the computing device, the plurality of 3D coordinates corresponding to the plurality of positions within the image; and
receiving, from the computing device, an indication of an augmentation and 3D coordinates associated with the augmentation.

19. The non-transitory computer-readable storage medium of claim 18 wherein the operations further comprise:
receiving an indication from the computing device to send next images.

20. The non-transitory computer-readable storage medium of claim 19 wherein the operations further comprise:
receiving a video stream from the computing device, the video stream comprising a plurality of images captured by an image capturing device of the computing device; and
displaying the video stream on a display of the XR wearable device.
